(19) United States
(12) Patent Application Publication
(10) Pub. No.: US 2009/0142461 A1
(43) Pub. Date: Jun. 4, 2009

(54) Nixtamalization Procedure and Equipment Used in Said Procedure

(76) Inventor: Pablo Augustin Meouchi Saade, Estado de Mexico (MX)

Correspondence Address: IPHORGAN, LTD., 1130 LAKE COOK ROAD, SUITE 240, BUFFALO GROVE, IL, 60089, US

(21) Appl. No.: 11/795,744

(22) PCT Filed: Jan. 18, 2006
(86) PCT No.: PCT/MX06/00004

§ 371 Date: Oct. 1, 2008

(30) Foreign Application Priority Data
Jan. 21, 2005 (MX) PA/A/2005/000891
Dec. 20, 2005 (MX) PA/A/2005/014100

(51) Int. Cl. B02B 1/06

(52) U.S. Cl. 426/507

(57) ABSTRACT

The invention relates to the dough and pancake industry, and all new industries wherein a product undergoes nixtamalization. The invention more particularly relates to a nixtamalization process involving a rotary reactor, having improved operation parameters that are defined for optimum operation. The conditions of the inventive system are advantageous over those of prior art systems in that the resulting rotary reactor parameter levels produce a good-quality product while reducing the amount of fuel consumed per amount of finished product. The aforementioned conditions are as follows: the speed of rotation of the reactor, which is between 25 and 30 seconds per revolution; the temperature of the heating jacket, which is between 130 and 300° C.; the supply of steam to the nixtamalization chamber is either continuous or intermittent with a break period of between 20 and 120 seconds and injection of steam for between 30 and 90 seconds; the start nixtamalization temperature which is maintained at least between 60 and 70° C. and the end nixtamalization temperature which is maintained at between 85 and 90° C., while the post-nixtamalization conditioning water is maintained at a temperature between ambient temperature and 55° C.

### FIELD OF THE INVENTION

This invention is related to the industry of dough and tortillas, and any new industry in which nixtamalization of any product is required, more specifically, it is related to a process of nixtamalization with a rotary reactor, with parameters of functions better defined for optimal functioning and a process with more interesting results in the finished product.

### BACKGROUND OF THE INVENTION

Since the development of a rotating reactor described in the present day Mexican Patent No. 191,283, it has been proven that various difficulties exist with respect to the adequate functioning of said reactor.

With the intention of achieving improved homogeneity in the temperature at the center of the trinomial, water-corn-lime, a rotary reactor was designed with the characteristics described in the Mexican Patent Application No. PA/a/2003/5529.

The inclusion of external ducts placed on the exterior walls of the reactor, besides increasing the contact surface, also allows for an increase in the time the working fluid stays in contact with the reactor. Mexican Patent Application No. PA/a/2004/1693, which is incorporated by reference herein, describes this innovation in the reactor.

A process which consists of washing the grains of corn before nixtamalization is already a state of the art step in the process of nixtamalization. The importance of this step is demonstrated in Mexican Patent Application No. PA/a/1994/09276 in which the traditional equipment used for nixtamalization is modernized.

However, there were parameters which needed to be defined, parameters such as the speed at which the reactor spins, the definition of the temperature of the gas in the chambers, the temperature of the slurry and the steam pressure which will be injected into the nixtamalization chamber, among others. And it was necessary to define these in order to obtain a product with adequate and consistent quality.

Although it was known that agitation was important, the magnitude of said agitation was not defined. It was also known that if a given vigor of agitation (speed of rotation of the reactor) was surpassed, the corn could be damaged, the cooking could be irregular and there could be steam leaks, and if the vigor of agitation was too little, the risk of darkening and even carbonization exists.

The basic principles of heat transfer through conduction establish that this transfer depends on the differential temperature between the hot body and the cold body, besides a constant transfer whose factors are not easily controlled. For this reason it is vitally important to determine the suitable temperature for the combustion fuel in order to achieve the desired temperature in the nixtamalization chamber.

With this warming behavior and specifically referring to heat transfer, it may be inferred that there are multiple parameters necessary for specifically controlling the functioning of the rotary reactors. Factors such as the surface of the outer wall of the reactor, the thermal insulation, the temperature of the consumables fed into the reactor (corn-water-lime) should all be defined in order to achieve an adequate functioning for optimal nixtamalization and optimal use of fuel by reducing the amount of gas needed for a given quantity of finished product.

An important step in this nixtamalization process which is also state of the art consists of washing the grains of corn before nixtamalization. This step shows the importance of Mexican Patent Application No. PA/a/1994/09276 in which modernization of traditional nixtamalization equipment is revealed and which consists basically of three steps which are: first, cleaning the corn by means of water with which the final washing of the corn can be eliminated; second, cooking the corn in an electric, electronic vat which works by means of electricity which warms heating elements which are placed around the vat and which warm the oil which is inside a chamber, by means of this system the water in which the corn will be cooked is heated. This vat, as may be seen, does not consume gas and therefore does not pollute; and finally, a cooling vat using air, thus eliminating the final washing process and thus also eliminating drainage pollution. With this invention the processing times are reduced and water as well as air pollution are reduced and an improved product is obtained since the residuals are not washed out in the water, allowing for a more integral product.

Although the use of washing the corn as a means of optimally making the best use of the lime in the process was mentioned, the conditions for washing the corn had not been determined, that is, the technique for washing, the temperature of the water used for washing, the ratio of water/grain or how to place the grain in contact with the water, etc. had not become state of the art.

Thus, besides the facet related to modifications in the rotary reactor, the present invention also deals with a modification in the nixtamalization process which includes a resting step for the nixtamal, the pre-treatment of the grain, conditioning the nixtamalized corn for resting, etc., of the nixtamal which would later be used to produce nixtamalized corn flour.

### SUMMARY OF THE INVENTION

One of the objectives of the present invention is to make available a process which allows for obtaining the desired temperature in the center of the trinomial water-lime-corn as quickly as possible.

Another of the objectives of the present invention is to determine the levels of the parameters for the rotary reactor for the purpose of obtaining a product of good quality.

Still another objective is to determine the levels of the parameters to reduce the consumption of fuel per amount of finished product.

Other objectives and advantages of the present invention shall become apparent upon studying the following description and the illustrations which accompany it with exclusively illustrative, not limiting, purposes.

Briefly, the present invention will be reflected in a process for the production of nixtamal and in another process for the equipment needed for the application of the first process and for the determination of various parameters of steam pressure fed into the nixtamalization chamber of the rotary reactor and the pattern for feeding said product, the temperature of the heating jacked, the speed at which the reactor spins and the temperature of the conditioning water for nixtamal, before resting.

With reference to the process, new steps have been added in the production of nixtamal which achieve an improved finished product, better consistency in the nixtamalized corn flour. It is important to mention that the parameters for the functioning of the reactor are for a reactor thermally insulated with mineral wool, with a capacity for processing 2,500 kilograms of corn in a batch type nixtamalization process.

In the process is included a step of washing the corn, in which said washing is carried out by emptying the corn into a receptacle which contains water and removing the corn which was in contact with the water, by means of a conveyor on the end opposite where the corn was unloaded. This step is previous to the nixtamalization with heat added. Thus, it could be determined in the present invention that the temperature of the trinomial corn-water-lime at the beginning of nixtamalization, when the corn and slurry are loaded is at least between 60° and 70° C. Thus, the temperature of the lime slurry is about 60 to 90° C.

As has already been mentioned, it has been sought for the drop in temperature of the grain in the last step of nixtamalization to be as rapid as possible. However, in order to carry out this drop in temperature in the rotary reactor itself presented a very important technical problem which was solved by removing the nixtamal from the reactor immediately after finishing the treatment time at a high temperature, and carrying out the cooling process at another site.

Therefore there is an additional step following nixtamalization with added heat and before the resting step. This step allows the temperature to drop for the resting and the absorption of additional water by the grain. Said step consists of passing the nixtamal through a receptacle containing water, similar to the way that the raw corn is washed. However, while in the washing impurities are removed from the corn, in the conditioning of the grain in this step the grain is simply cooled and then some water is absorbed by the nixtamal grain so that during the resting step this water is absorbed.

Maintaining all of the other parameters unchanged, it could be determined that the temperature in the heating chamber should be between 130 and 300° C., with an optimal range being between 160 and 210° C.

The third modification in the process, since even with the modification in the jackets of the rotary reaction the desired temperature was not reached for the trinomial corn-water-lime, consisted of adding an additional source of heat: pressurized steam injected directly into the center of the trinomial corn-water-lime.

For this modification to take place, it was necessary to modify the reactor, adding a means for injecting the steam directly into the center of the trinomial.

This option raises the possibilities of heating. Heating may take place by means of diverse working fluids in the jacket or outer chamber or even by means of electric heating elements attached to the outer wall of the nixtamalization chamber and also, this, in combination with the injection of steam into the center of the trinomial. However, it is also possible to use only the steam injection as the only source of heat.

This steam is characterized as being at a pressure of between 2 and 10 kg/cm². And the amount added is that which is necessary in order to reach and maintain the nixtamalization temperature.

After various tests, it was determined that the speed at which the reactor spins, in order for proper nixtamalization to occur, would be between 25 and 30 seconds per spin.

The range of steam pressure fed into the nixtamalization chamber is between 1 and 10 kg/cm².

Depending on the type of corn to be nixtamalized, the type of end product (nixtamalized flour, for making tortillas, for fried snacks, etc), and the processing time, the feeding of steam is continuous until the nixtamalization temperature reaches 85° C. to 95° C.

The temperature of the conditioning water for the nixtamal, immediately after leaving the reactor, is from room temperature to 55° C.

Following are illustrations in order to better understand the features of the invention, with respect to the equipment, which accompany this document for strictly illustrative but not limiting purposes.

### BRIEF DESCRIPTION OF THE DRAWINGS

FIG. 1 shows the scheme of the process which is the object of the present invention.

FIG. 2 illustrates the modification carried out on the rotary reactor for the injection of steam.

To better understand the invention, we will now make a detailed description of some of the aspects of said invention, shown in the illustrations and examples which are annexed to the present description with illustrative but not limiting purposes.

### DETAILED DESCRIPTION OF THE INVENTION

As has already been mentioned, there are two aspects of this invention, on the one hand the teachings about a new process of nixtamalization for the production of nixtamal which is later ground and dried to obtain nixtamalized corn flour. And on the other hand, it reveals the equipment needed for the application of this new process.

With respect to the process, the invention consists of a series of modifications which consist of three additional steps in the process and one modification in the way the heat of the reactor carries out the nixtamalization process.

The modification of the reactor to adapt for the modification in the way the heat works consists of including in said reactor an injection means for injecting steam directly into the trinomial corn-water-lime in order to heat it.

Until now, the nixtamalization process in a rotary reactor has taken place in the following manner: 1) the corn is cleaned using sieves, 2) the grain is washed in water, 3) nixtamalization is begun in the reactor, 4) the nixtamal is sent to the resting vats and later 5) the nixtamal is ground.

This process presented some inconveniences which were reflected in the organoleptic characteristics and in the variability of the flour produced from nixtamal so produced.

One of the modifications is the determination of the step of washing the grain in water with respect to temperature, amount of water and how to carry out said washing. The step of washing is carried out by unloading the corn into a receptacle containing water and extracting the water which was in contact with the grain.

Although in one of the variations, this step takes place using a conveyor which reaches to the bottom of the receptacle, generally inverted pyramid in shape, extracting the corn from the opposite end from where it was unloaded, other types of receptacles and means for extracting the corn are possible. For example, extraction of the corn may be carried out through the bottom of the receptacle. An agitation means may also be incorporated into the receptacle to improve the elimination of dust which adheres to the external surface of corn.

This step is previous to nixtamalization with added heat.

The amount of water used for washing has been proven to be between 120 and 1000 liters per ton of processed corn, presenting improvement throughout the process, however, it was found that the optimum would be about 355 liters per ton of processed corn being washed, for corn with powdered impurities the size of average sized particles of dust.

The temperature of the water is another parameter to be taken into account, since water at a higher temperature allows for better cleaning. Temperatures of between room temperature and 90° C. were tried for the washing. It was determined that the optimum for saving fuel and for the best washing was 85° C.

Another modification consists of conditioning nixtamal before sending it to the resting vat. This conditioning consists of forcing the nixtamal through a certain amount of water at a certain temperature. This conditioning is not washing since the nixtamal which is forced through absorbed added lime and all the water which was added to the reactor. On the other hand, the residual water, after having the nixtamal forced through it, does not contain significant amounts of lime nor of components of nixtamal.

Rather, this conditioning serves two functions, one of which is for any type of corn flour and the other depends on the application of said flour. The most general function is adding superficial water to the nixtamal so it would be absorbed in the resting act.

The other function, which is exclusively for the production of corn flour to be used to make tortillas, is that of lowering the temperature of the nixtamal. For flour which will be used for making fried snacks, it would even be advantageous to raise the temperature of the resting grain.

The characteristics of the process are based on the amount of water through which the nixtamal will be passed and the temperature of this water. Various ranges of water temperature were tried, finding that the most adequate temperature was from room temperature to 90° C., the optimum temperature for nixtamalized corn flour to be used in the production of tortillas was room temperature and for nixtamalized corn to be used in producing fried snacks the optimum temperature was between 37 and 80° C.

The amount of water through which the nixtamal is to be forced was determined to be between 13 and 180 liters for every ton of corn transformed into nixtamal, the optimal range being between 97 and 106 liters per ton of corn transformed into nixtamal.

Following the step of passing the nixtamal through the conditioning water, unabsorbed water is eliminated. In one of the incorporations, the unabsorbed water is eliminated by means of one or more sieves.

The third modification in the process, due to the fact that even with the modification of the jackets on the rotary reactor the desired temperature for the trinomial corn-water-lime was not reached, consisted of adding an additional source of heat: pressurized steam injected directly into the center of the trinomial corn-water-lime.

Various means may be used for injecting heat, from a simple tube with gradations, to tubes with nozzles and spray heads. Obviously the placing of these means should not interfere with the ridges on the inside of the nixtamalization chamber for dragging the mixture, a rather complicated aspect due to the inclination of the reactor.

This modification in the process had to be reflected in the modifications in the reactor, adding a means for injecting the steam directly into the center of the trinomial. This option increases the possibility of heating. Heating may be carried out through the use of various working fluids in the jacket or outer chamber or even by means of electrical heating elements adhered to the outer wall of the nixtamalization chamber and also, this in combination with injecting steam into the center of the trinomial. However, it is also possible to use the injection of steam as the only source of heat.

The steam pressure which was determined to be appropriate was between 2 and 10 kg/cm². And the amount added is what is necessary to reach and hold the nixtamalization temperature. It is understood that the amount of water to be added in the form of steam must be taken into account when making the balance of the amount of water which will be added in the form of the lime slurry, because at the end of the cooking process for the corn there should be no cooking residues.

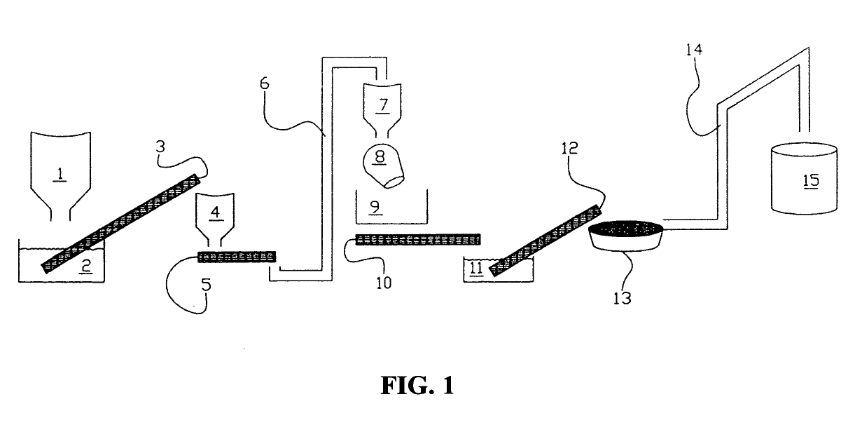

Now, with reference to the figures: it has been indicated that FIG. 1 shows the scheme of the process which is the object of the present invention. In this scheme the places that the new steps are to take place are indicated.

In the preferred incorporation, the process begins with the reception of the corn at the site of the corn sieve 1. From here the corn is continuously sent to the washing vat 2, where the dust that is on the outside of the grains is washed off by means of moving the corn through the water and by means of the temperature of the water itself. The conditions for this washing have already been described in this same chapter.

A conveyor takes the washed corn from the washing vat and deposits it on the scale for weight control. From the scale, by means of another conveyor 5 and an elevator 6 the corn is deposited in the feeding vat 7 of the nixtamalization reactor 8. Including in the process a feeding vat for the reactor significantly reduces the feeding operation since the vat can be filled while the reactor is nixtamalizing a load and the feeding vat can be fed another complete load so that this operation, the operation of loading the reactor takes place in ⅓ the time it normally took before including said vat.

Reactor 8 is loaded with corn and the lime slurry and the step of nixtamalization with heat takes place. After the treatment, when the corn has absorbed essentially all the water and all the lime and most of the transformations which transform corn into nixtamal have taken place, this mixture is emptied into vat 9.

Vat 9 deposits the still hot nixtamal on the conveyor belt 10 which carries the nixtamal to the conditioning vat 11 where the nixtamal absorbs water and reaches the temperature of the water. The conditioned nixtamal is taken from the vat to a means for eliminating 13 the excess water, to only conserve the water which has been absorbed.

The nixtamal with the absorbed water is sent to the resting receptacle 15 by way of a conveyor 14, and is kept in this receptacle as long as is necessary for this step, for the nixtamal to stabilize and the absorbed water to be absorbed.

With this step the nixtamalization process is complete and the nixtamal is sent to be ground and then said ground grain is dried to thus obtain nixtamalized corn flour.

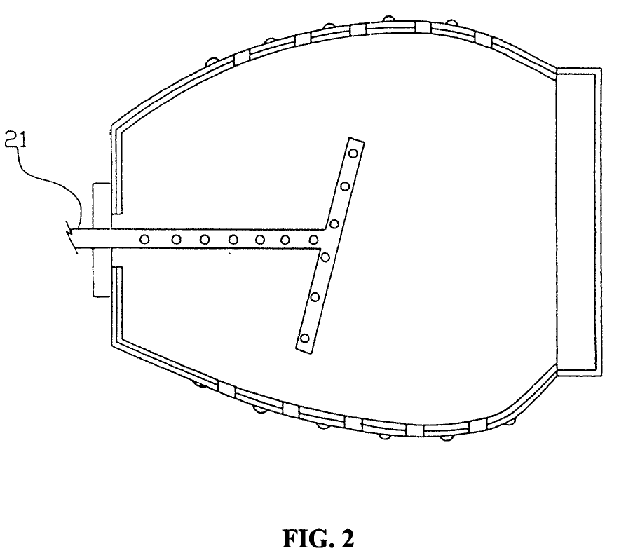

FIG. 2 shows the modification which takes place in the rotary reactor with the injection of steam. The modification consists of providing the reactor with an injecting means for the steam 21 as shown in the scheme of said FIG. 2.

It is convenient to remember that the parameters which are the object of the present invention are for a rotary reactor, insulated with mineral wool, with two tapered conical sections with the ends of lesser diameter on the outside ends, an effective capacity of 2,500 kg and with the beginning temperature in the trinomial corn-water-lime being at least 60 to 70° C.

The pressure for the steam which is injected into the nixtamalization chamber was established as between 1 and 10 kg/cm².

In order to determine these parameters various tests which are shown in the following examples were performed.

### EXAMPLES

### Example 1

While keeping all the parameters constant except the speed at which the reactor spins, four different speeds of spins were tried: spins of 18-22 seconds per spin, spins of 23-27 seconds, spins of 28-32 seconds per spin and spins of 33-37 seconds per spin.

In the treatment of spins at an average of 35 seconds per spin grains were not properly nixtamalized and grains were over nixtamalized and it was also observed that at this speed the steam being fed into the center of the trinomial was not incorporated and also leaked out from the nixtamalization chamber.

In treatments at an average spinning speed of 25 and 30 seconds per spin, nixtamalization was correct and no steam leaks occurred.

Finally in a treatment at 20 seconds, darkened and even burned grains were obtained, making this speed not recommendable.

### Example 2

While keeping all the parameters constant except the temperature of the warming jacket of the reactor, four temperatures were tested: 125, 130, 160 and 300° C. on an average.

In the treatment at an average temperature of 125° C. in the warming jacket, the required temperature in the nixtamalization chamber was not reached during the normal nixtamalization time (an average of 40-60 minutes).

In treatment at an average temperature of 130° C. in the warming jacket the required temperature was reached in the nixtamalization chamber during the normal nixtamalization time period (an average of 40-60 minutes), however it was reached very late in the process but the objectives of the process were achieved.

In treatment at an average temperature of 160° C. in the warming jacket the required temperature was reached in the nixtamalization chamber during the normal nixtamalization time period (an average of 40-60 minutes), and the temperature was reached in an adequate time frame.

In treatment at an average temperature of 190-210° C. in the warming jacket the required temperature was reached in the nixtamalization chamber during the normal nixtamalization time period (an average of 40-60 minutes), the temperature was reached quickly and with no additional problems in the finished product, achieving flour with good characteristics.

In treatment at an average temperature of 230 to 300° C. in the warming jacket the required temperature was reached in the nixtamalization chamber in the normal nixtamalization time period (an average of 40-60 minutes), the temperature was reached very quickly. However, the finished product (nixtamalized corn flour) was darkened, especially in dough and tortillas.

### Example 3

After various tests it was determined that the patterns for injecting steam could vary according to the type of corn and the nixtamalization time required to obtain the desired product.

A balance was reached between the heat provided in the nixtamalization chamber by the steam and that provided in the heating jacket.

If the cooking time is less than 30 minutes, both forms of heat may be used without permitting the temperature of the trinomial corn-water-lime to rise above the maximum temperature established for the chosen nixtamalization process.

If the cooking time is over 30 minutes, intermittent steam injections are recommended, with pauses between injections of between 20 and 120 seconds and injections of between 30 and 90 seconds.

### Example 4

After multiple tests it could be determined that the temperature of the conditioning water influences two aspects of the finished product: the color and the moisture in the flour. At temperatures near room temperature the product produced may be a little yellowish without over-cooking, rendering good texture in dough and tortillas.

When the temperature surpasses 55° C., the color is acceptable and hydration is good, but the product is over-cooked which may cause stickiness when the product is rehydrated (dough and/or tortillas).

Therefore, the accepted temperature range is between room temperature and 55° C.

The invention has been sufficiently described so that a person with general knowledge in the field may reproduce and obtain the results mentioned in the present invention. However, any person with knowledge in the state of the art of the present invention may make modifications not described in the present application, however, if for the application of these modifications of a determined structure or for the process of manufacturing the same, the material claimed in the following claims is required, said structures shall be considered within the scope of the invention.

I claim:

1. A procedure for nixtamalization, characterized by consisting of a step of conditioning the grain previous to resting and after removing the grain from the reactor, said conditioning consists of forcing the grain through a predetermined amount of water in order to provide absorbed water to the grain.

2. A procedure for nixtamalization, as claimed in the claim 1, wherein the total amount of the water used in conditioning being between 13 and 180 liters per ton of processed corn, at a temperature of between room temperature and 92° C.

3. A procedure for nixtamalization, as claimed in the claim 2, wherein the total amount of water used in conditioning being between 97 and 106 liters per ton of processed corn.

4. A procedure for nixtamalization, as claimed in claim 3, further comprising a step of washing in water the corn which is to be nixtamalized, this washing taking place in water between room temperature and 90° C., in an amount of between 120 and 1000 liters per ton of processed corn.

5. A procedure for nixtamalization, as claimed in claim 1, wherein the washing step takes place in water at a temperature of 85° C. in an amount of water of 355 liters per ton of processed corn.

6. A procedure for nixtamalization, as claimed in claim 5, wherein the heating for nixtamalization is obtained by, in the rotary reactor, injecting steam at a pressure of between 2 and 3 kg/cm² into the center or the trinomial corn-water-lime until a temperature of between 72 and 90° C. is reached.

7. A procedure for nixtamalization, as claimed in claim 1, further comprising a step of washing in water the corn which is to be nixtamalized, this washing taking place in water between room temperature and 90° C., in an amount of between 120 and 1000 liters per ton of processed corn.

8. A procedure for nixtamalization, as claimed in claim 2, further comprising a step of washing in water the corn which is to be nixtamalized, this washing taking place in water between room temperature and 90° C., in an amount of between 120 and 1000 liters per ton of processed corn.

9. A procedure for nixtamalization, as claimed in claim 4, wherein the heating for nixtamalization is obtained by, in the rotary reactor, injecting steam at a pressure of between 2 and 3 kg/cm² into the center or the trinomial corn-water-lime until a temperature of between 72 and 90° C. is reached.

10. A procedure for nixtamalization, as claimed in claim 3, wherein the heating for nixtamalization is obtained by, in the rotary reactor, injecting steam at a pressure of between 2 and 3 kg/cm² into the center or the trinomial corn-water-lime until a temperature of between 72 and 90° C. is reached.

11. A procedure for nixtamalization, as claimed in claim 2, wherein the heating for nixtamalization is obtained by, in the rotary reactor, injecting steam at a pressure of between 2 and 3 kg/cm² into the center or the trinomial corn-water-lime until a temperature of between 72 and 90° C. is reached.

12. A procedure for nixtamalization, as claimed in claim 1, wherein the heating for nixtamalization is obtained by, in the rotary reactor, injecting steam at a pressure of between 2 and 3 kg/cm² into the center or the trinomial corn-water-lime until a temperature of between 72 and 90° C. is reached.

13. Conditions for nixtamalization, using a rotary reactor, with a warm air jacket and steam feeding in the nixtamalization chamber, said conditions characterized by the speed at which the reactor spins varying between 25 and 30 seconds per spin, the temperature of the jacket being between 130 and 300° C., the feeding of steam in the nixtamalization chamber being continuous or intermittent at intervals of resting of between 20 and 120 seconds and an injection of steam every 30 to 90 seconds (steam pressure of between 1 and 10 kg/cm²). At the beginning the temperature for nixtamalization should be at least 60 to 70° C., keeping the temperature for nixtamalization at the end of the process at between 85 and 95° C. and the conditioning water following nixtamalization is handled at temperatures of from room temperature to 55° C.

14. Conditions for nixtamalization, using a rotary reactor with a hot air warming jacket, as claimed in claim 13, characterized by the temperature of the warming jacket being maintained between 160 and 190° C.
